(19) United States
(12) Patent Application Publication
(10) Pub. No.: US 2012/0280911 A1
(43) Pub. Date: Nov. 8, 2012

(54) INDICATING DEVICE USED FOR A PROJECTION SYSTEM

(75) Inventor: Tzu-Wei SU, Taoyuan Hsien (TW)

(73) Assignee: DELTA ELECTRONICS, INC., Taoyuan Hsien (TW)

(21) Appl. No.: 13/368,944

(22) Filed: Feb. 8, 2012

(30) Foreign Application Priority Data
May 4, 2011 (TW) 100115539

(51) Int. Cl. G09G 5/08

(52) U.S. Cl. 345/166

(57) ABSTRACT

An indicating device used for a projection system is provided. The indicating device comprises a body, a transmission device and a photovoltaic conversion device. The transmission device is disposed in the body to emit a signal. The photovoltaic conversion device is disposed on the body and partially converts the optical energy into electrical power for the projection image.

This application claims the benefit of the priority to Taiwan Patent Application No. 100115539 filed on May 4, 2011, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to an indicating device used for a projection system. More particularly, the present invention relates to a device capable of converting optical energy from a projection image into electrical power and actively indicating the projection image by means of wireless transmission in a projection system.

2. Descriptions of the Related Art

Commercially available indicating devices for use with projection apparatuses have various forms and functions. As one of the most commonly used indicating devices, a laser pointer can generate a light spot to indicate important portions at any time; as a result, it has become an indispensable tool for use in presentations.

The functions of the different parts of conventional laser pointers have become increasingly more sophisticated through continuous improvement. Accordingly, apart from the basic indicating function, laser pointers of the new generation also have some simple control functions; for example, they can be used to remotely control a computer to switch between pages so that the presentation will not be interrupted due to the operation of the computer. However, the primary function of the laser pointer is still to generate a light spot on the projection image for indicating purposes; thus, this function consumes a great amount of power and batteries thereof and must be replaced frequently. If large-capacity batteries are used, the laser pointer becomes bulky in volume.

Furthermore, presentation software currently available has become very sophisticated. For example, if an important portion of a presentation needs to be indicated, the user can use the mouse of the computer to switch presentation software to a paintbrush function or uses a drawing pen and a drawing tablet specially used for computer graphics to write notes or to circle the important portion for labeling purposes in the presentation file. However, switching between features has the following drawbacks for the following reasons: (1) since the switch to the drawing pen mode cannot be accomplished by the laser pointer directly but must be accomplished by operating the computer and computer graphics tools, the presentation has to be interrupted and (2) the presentation file itself must be edited during use, so when the computer is switched to the drawing pen mode and the mouse is used to circle the important portion, circling tracks are generated by random dragging, so it is difficult to neatly circle the important portion in the projection image.

### SUMMARY OF THE INVENTION

An objective of the present invention is to provide an indicating device used for a projection system. Because an image projected by the projection system has sufficient optical energy, the indicating device of the present invention is provided with a photovoltaic conversion device to convert the optical energy into the electrical power for use by the indicating device itself Thereby, the problem of battery replacement can be addressed by the indicating device of the present invention.

Another objective of the present invention is to enable the indicating device to actively emit a signal so that the projection system can recognize a position of the indicating device relative to the image. Then, the projection system can record the position of the indicating device and display it on the image in real time. In this way, adding symbols, underlines or boxes in the image can be directly performed during the presentation process without having to operate the computer, which makes the presentation process smoother. Conceivably, this not only makes the operation simple but also allows labels added to appear neatly in a more desired way.

To achieve the aforesaid objective, the present invention provides an indicating device used for a projection system. The indicating device comprises a body, a transmission device and a photovoltaic conversion device. The transmission device is disposed in the body to emit a signal. The photovoltaic conversion device is disposed on the body to partially convert optical energy from the projection system for projecting an image into electrical power and to provide the electrical power for the transmission device.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of an indicating device according to the first embodiment of the present invention;

FIG. 2A is a schematic view of a projection system according to the first embodiment of the present invention;

FIG. 2B is a schematic view of another projection system according to the first embodiment of the present invention;

FIG. 3 is a schematic view illustrating operations of the indicating device of the present invention when used in the projection system;

FIG. 4 is a schematic view of an indicating device according to the second embodiment of the present invention;

FIG. 5 is a schematic view of a projection system according to the second embodiment of the present invention;

FIG. 6 is a schematic view of an indicating device according the third embodiment of the present invention; and

FIG. 7 is a schematic view of a projection system according to the third embodiment of the present invention.

### DESCRIPTION OF THE PREFERRED EMBODIMENT

In the following description, the present invention will be explained with reference to embodiments thereof. However, the description of these embodiments is only for the purpose of illustration rather than limitation. It should be appreciated that in the following embodiments and the attached drawings, elements unrelated to the present invention are omitted from depiction. The dimensional relationships among individual elements in the attached drawings are illustrated only for ease of understanding, but not to limit the actual scale.

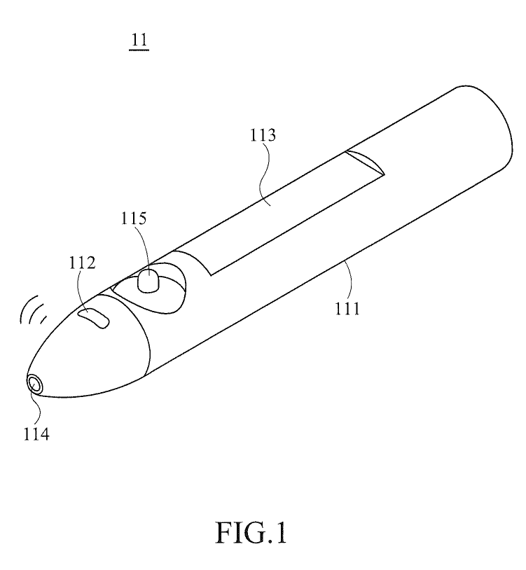

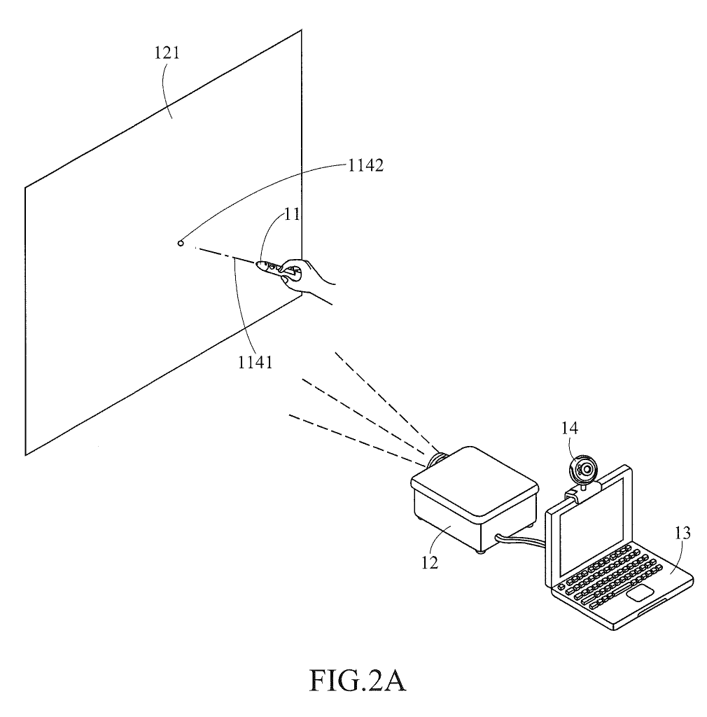

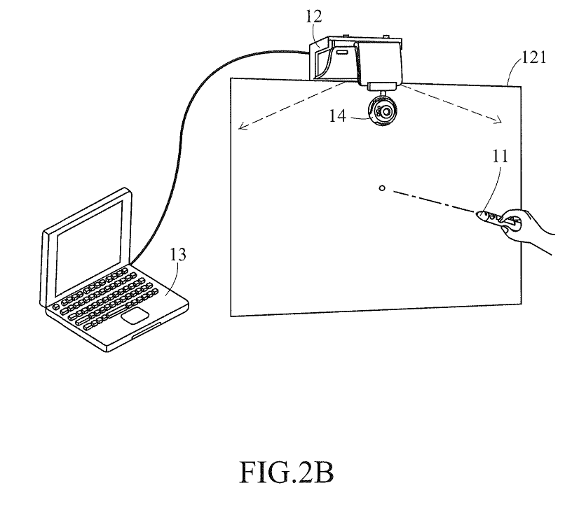

The present invention relates to an indicating device 11 used for a projection system 1; the first embodiment of which is shown in FIG. 1 and FIG. 2A. FIG. 1 is a schematic view of the indicating device 11, and FIG. 2A is a schematic view illustrating the application of the indicating device 11 in the projection system 1. The projection system 1 further comprises a projection device 12, a processor 13 and a receiving device 14. The projection device 12 is configured to project an image 121; the receiving device 14 is configured to receive a signal; and the processor 13 is electrically connected to the receiving device 14 and is configured to determine the position information of the indicating device 11 from the signal.

The indicating device 11 comprises a body 111, a transmission device 112 and a photovoltaic conversion device 113. The transmission device 112 is disposed in the body 111 to emit a signal, which is to be converted into position information of where the indicating device 11 is located relative to the image 121. The photovoltaic conversion device 113 is disposed on the body 111 to partially convert the optical energy from the projection system for projecting the image 121 into electrical power and to provide electrical power for the transmission device 112 or other components. More specifically, the photovoltaic conversion device 113 may be a solar panel and is disposed on the outer surface of the body 111. When the indicating device 11 is located within the range of the image, the solar panel can partially convert the optical energy into electrical energy, so the indicating device 11 can be charged at any time when the optical energy for the image 121 impinges on the indicating device 11.

The indicating device 11 is preferred to further comprise a visible light source 114 disposed at one end of the body 111. The visible light source 114 may be a light emitting diode (LED) bulb or some other light emitting element that can provide functions similar to a conventional laser pointer; however, those of ordinary skill in the art may replace it with any element capable of emitting visible light; thus, the present invention has no limitation on the visible light source.

Hereinbelow, the way in which the indicating device 11 of this embodiment is used will be detailed.

The basic function of the indicating device 11 is to emit a visible light ray 1141 from the visible light source 114 to generate a visible light spot 1142 on an image 121 projected by the projection device 12 so that audiences can clearly know a position where the user is indicating in the image. One of the key points of the present invention is that the transmission device 112 of the indicating device 11 also emits a signal, and the signal is received by the receiving device 14 and then transmitted to the processor 13. Then, the processor 13 can determine the position information of where the indicating device 11 is located relative to the image 121 according to the signal emitted by the transmission device 112. In this embodiment, the transmission device 112 is an infrared (IR) emitter, while the receiving device 14 is a CCD camera or a CCD/CMOS sensor.

FIG. 2B shows another preferable embodiment that the indicating device 11 is also capable of being used for an ultra short throw projector. The projection device 12 (i.e., an ultra short throw projector) is operatively disposed adjacent to the screen. In FIG. 2B, the projection device 12 is shown as being disposed at the top of the image 121; however, it is also practicable to dispose the projection device 12 at the bottom of the image 121. The receiving device 14 is disposed with the projection device 12 to receive the signal emitted from the indicating device 11 and then transmit the signal to the processor 13. Then, the processor 13 would be able to determine the position information of where the indicating device 11 is located relative to the image 121 according to the signal emitted by the transmission device (not shown). In this embodiment, it is advantageous in that the indicating device 11 would be less likely to shelter or interference the light beams projected from the projection device 12.

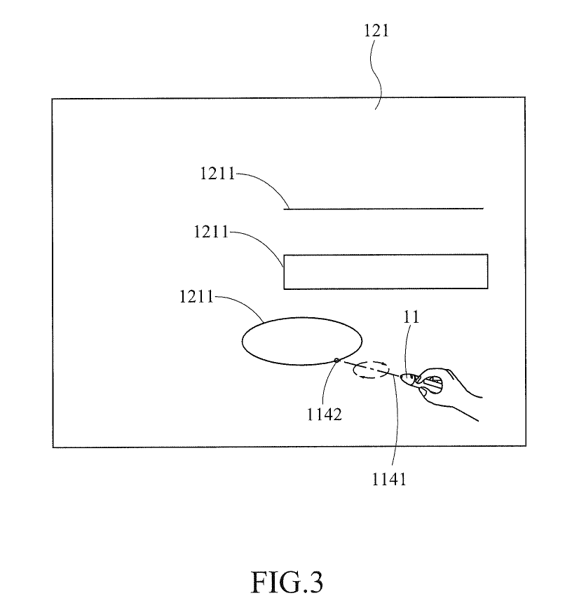

The indicating device 11 of this embodiment may also be used in another way. Referring to FIG. 3, the indicating device 114 further has an interactive button 115. If the user depresses the interactive button 115 continuously when the indicating device 11 moves relative to the image 121, the processor 13 will continuously record the position information of the indicating device 11 and immediately display a moving route 1211 of the indicating device 11 on the image 121 so that the symbols, underlines or boxes can be labeled in real time. Once the user releases the interactive button 115, the processor 13 will stop recording the position information of the indicating device 11. Additionally, the interactive button 115 may also be able to turn the visible light source 114 on or off. For the types and operational modes of the interactive button 115 described above, other implementations may also be devised by those skilled in the art and the present invention has no limitation on this.

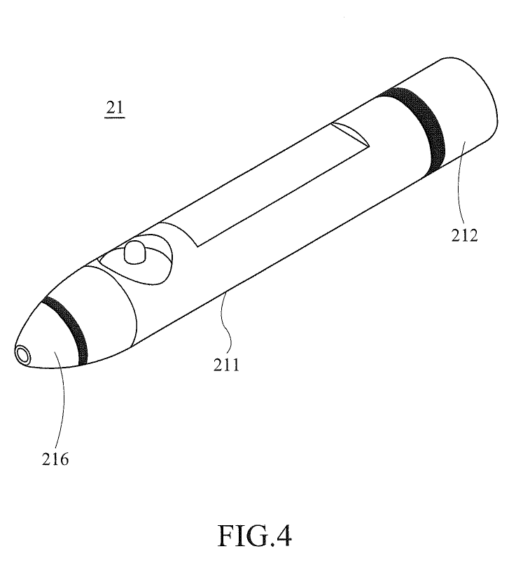

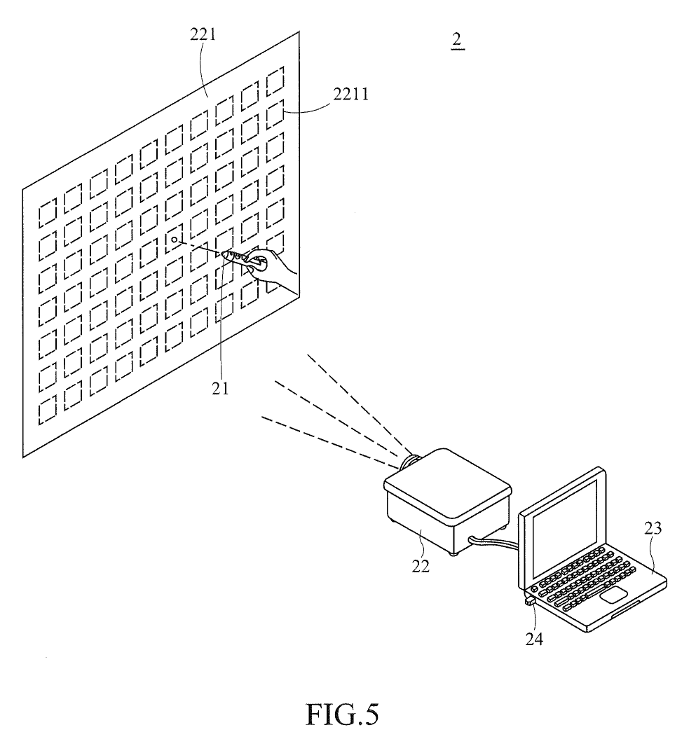

The second embodiment of the present invention is shown in FIG. 4 and FIG. 5, which are schematic views of an indicating device 21 of the second embodiment. This embodiment is also an indicating device 21 used for a projection system 2. The projection system 2 may further comprise a projection device 22, a processor 23 and a receiving device 24. The indicating device 21 of this embodiment is substantially similar to that of the first embodiment, so similarities therebetween will not be described again herein.

Referring to FIG. 5, it illustrates the method in which the projection system 2 according to the second embodiment of the present invention is used. It shall be appreciated that the second embodiment differs from the first embodiment mainly in that the transmission device 112 adopted in the indicating device 11 is a radio frequency (RF) emitter 212, while the indicating device 21 of the second embodiment further comprises a photo sensor 216 disposed at one end of the body 211. According to this embodiment, an image 221 includes a plurality of micro patterns 2211 distributed therein; for example, a lot of micro barcodes or labels which will not influence the audiences' visual sense are distributed on a projection screen for projecting the image 221. The photo sensor 216 detects a micro pattern 2211 corresponding to a position where the photo sensor is located to generate a corresponding signal for transmission from the RF emitter 212. Then, the signal is received by the receiving device 24 and transmitted to the processor 23 so that the processor 23 can recognize and obtain the position information of the indicating device 21 according to the signal. The micro patterns 2211 may be arranged either regularly in the form of a matrix or irregularly depending on the user's desires; other similar implementations may also be devised by those skilled in the art. The corresponding positional and operational relationships among other components are all identical to those of the first embodiment, so no further description will be made herein.

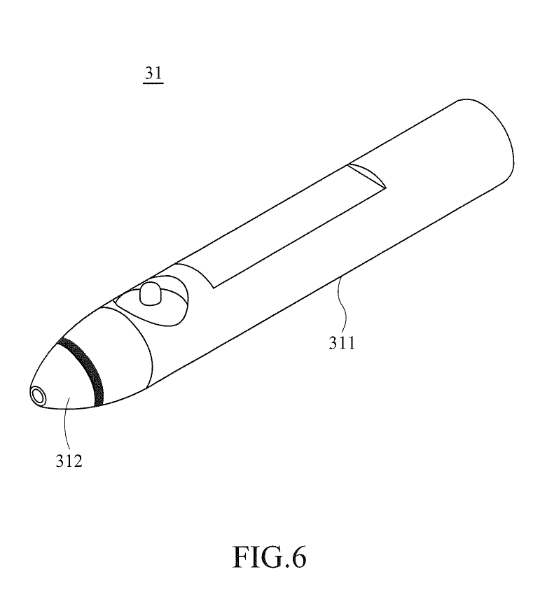

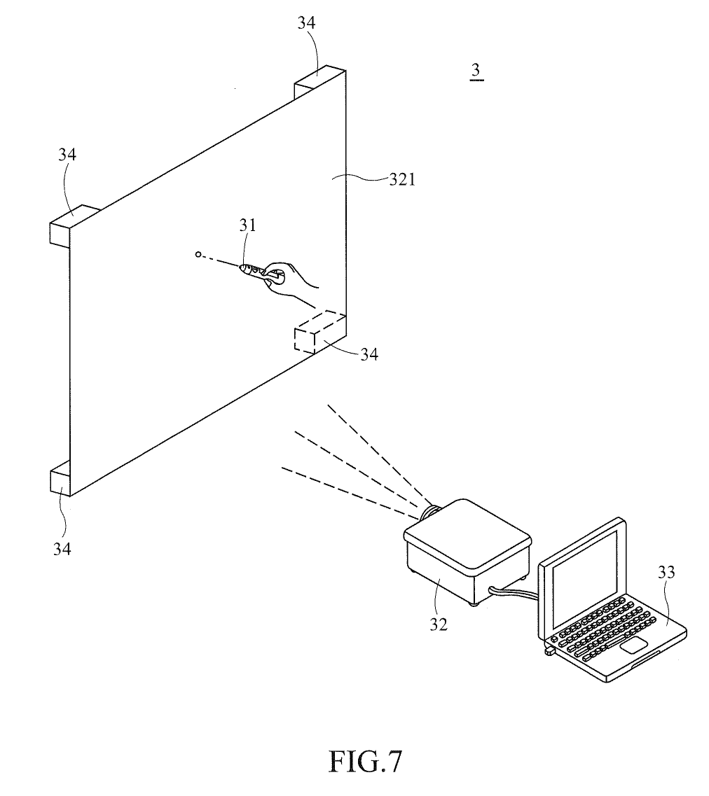

The third embodiment of the present invention is shown in FIG. 6 and FIG. 7. The third embodiment is also an indicating device 31 used for a projection system 3. FIG. 6 is a schematic view of the indicating device 31 of this embodiment, and FIG. 7 is a schematic view of a projection system 3 of this embodiment.

Likewise, the projections system 3 may further comprise a projection device 32, a processor 33 and a receiving device 34. The indicating device 31 of this embodiment is substantially similar to those of the previous embodiments, so similarities therebetween will not be further described herein.

Referring to FIG. 7 the third embodiment differs from the first and second embodiments mainly in that the transmission device 312 adopted in the indicating device 31 of the third embodiment is an ultrasonic emitter, while the receiving device 34 is an ultrasonic receiver disposed at a periphery of an image 321. For example, the receiving device 34 comprises four ultrasonic receivers disposed at four corners of the image 321 respectively. However, other similar implementations may also be devised by those skilled in the art, so no limitation is made on the ultrasonic receiver(s) herein. The receiving device 34 transmits a corresponding signal to the processor 33 for processing so that the position information of the indicating device 31 can be determined by the processor 33 according to the position where the processor 33 is located relative to the ultrasonic emitter when emitting the signal. The corresponding positional and operational relationships among other components are all identical to those of the first and the second embodiments, so no further description will be made herein.

According to the above descriptions, an indicating device of the present invention that has a photovoltaic conversion device can convert optical energy from the projection device into electrical power necessary for the indicating device, so the problem of frequently replacing the batteries as in the conventional indicating devices can be solved. Furthermore, because the indicating device of the present invention can further emit a signal actively, the projection system can recognize the position of the indicating device relative to the image and display the position on the image in real time; in this way, the user can add symbols, underlines, boxes or the like in the image at any time without having to operate the computer during a presentation. This makes the presentation process smoother and more convenient to make labels.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An indicating device used for a projection system, the indicating device comprising:
a body;
a transmission device disposed in the body to emit a signal; and
a photovoltaic conversion device disposed on the body to partially convert optical energy from the projection system for projecting an image into electrical power and to provide the electrical power for the transmission device.

2. The indicating device as claimed in claim 1, wherein the projection system comprises a projection device adapted to project the image.

3. The indicating device as claimed in claim 2, wherein the signal is capable of being converted into position information of where the indicating device is located relative to the image.

4. The indicating device as claimed in claim 3, wherein the projection system further comprises a receiving device to receive the signal.

5. The indicating device as claimed in claim 4, wherein the projection system further comprises a processor electrically connected with the receiving device, and the processor is capable of determining the position information from the signal.

6. The indicating device as claimed in claim 5, wherein the transmission device is an infrared (IR) emitter, and the receiving device is a CCD camera or a CCD/CMOS sensor, and wherein the processor determines the position information according to where the infrared emitter is located relative to the image when the signal is emitted.

7. The indicating device as claimed in claim 5, wherein the transmission device is a radio frequency (RF) emitter.

8. The indicating device as claimed in claim 7, wherein the indicating device further comprises a photo sensor disposed at an end of the body.

9. The indicating device as claimed in claim 8, wherein the image includes a plurality of micro patterns distributed therein, the photo sensor detects the micro pattern corresponding to where the photo sensor is located to generate the signal, and the processor obtains the position information according to the signal.

10. The indicating device as claimed in claim 5, wherein the transmission device is an ultrasonic emitter, and the receiving device comprises at least one ultrasonic receiver disposed at a periphery of the image.

11. The indicating device as claimed in claim 10, wherein the processor determines the position information according to where the ultrasonic emitter is located relative to the at least one ultrasonic receiver when the ultrasonic emitter emits the signal.

12. The indicating device as claimed in claim 5, wherein the processor continuously records the position information and displays a corresponding route in the image.

13. The indicating device as claimed in claim 3, wherein the photovoltaic conversion device comprises a solar panel disposed on an outer surface of the body.

14. The indicating device as claimed in claim 3, wherein the indicating device further comprises a visible light source disposed at an end of the body.
